(19) United States
(12) Patent Application Publication
(10) Pub. No.: US 2022/0291553 A1
(43) Pub. Date: Sep. 15, 2022

(54) DISPLAY PANEL AND DISPLAY DEVICE

(71) Applicants: Hefei BOE Display Technology Co., Ltd., Anhui (CN); BOE TECHNOLOGY GROUP CO., LTD., Beijing (CN)

(72) Inventors: Yajun LI, Beijing (CN); Heng ZHANG, Beijing (CN); Yueming CHEN, Beijing (CN); Yunhua FANG, Beijing (CN); Kai WANG, Beijing (CN)

(21) Appl. No.: 17/511,921

(22) Filed: Oct. 27, 2021

(30) Foreign Application Priority Data
Mar. 15, 2021 (CN) 202110277805.0

(51) Int. Cl. G02F 1/1337; G02F 1/1347

(52) U.S. Cl. CPC G02F 1/133738; G02F 1/133749; G02F 1/1347

(57) ABSTRACT

Embodiments of the present application provide a display panel and a display device. The display panel comprises: a first substrate; a second substrate arranged opposite to the first substrate; a liquid crystal layer between the first substrate and the second substrate; a first alignment layer on a side of the first substrate facing the second substrate; and a second alignment layer on a side of the second substrate facing the first substrate; wherein a rotation angle of an alignment direction of the second alignment layer with respect to an alignment direction of the first alignment layer is greater than 0 degree.

### RELATED APPLICATION

The present application claims the benefit of Chinese Patent Application No. 202110277805.0 filed on Mar. 15, 2021, the entire disclosure of which is incorporated herein by reference.

### TECHNICAL FIELD

The present disclosure relates to the field of display technologies, especially to a display panel and a display device.

### BACKGROUND

In a large-sized advanced super dimension switch (ADS) TV liquid crystal display panel, the direction of the liquid crystal is parallel to the panel. In the L0 state (dark state), the display panel has a low contrast ratio under a high brightness. Therefore, it is desired to propose a solution enhancing the contrast ratio of the large-sized ADS TV liquid crystal display panel.

### SUMMARY

As a first aspect of the embodiments of the present disclosure, an embodiment of the present disclosure provides a display panel comprising: a first substrate; a second substrate arranged opposite to the first substrate; a liquid crystal layer between the first substrate and the second substrate; a first alignment layer on a side of the first substrate facing the second substrate; and a second alignment layer on a side of the second substrate facing the first substrate; a rotation angle of an alignment direction of the second alignment layer with respect to an alignment direction of the first alignment layer is greater than 0 degree.

In some implementations, a long axis direction of liquid crystal molecules in the liquid crystal layer is parallel to at least one of a surface of the first substrate and a surface of the second substrate.

In some implementations, a direction in which the alignment direction of the second alignment layer is rotated with respect to the alignment direction of the first alignment layer is an alignment rotation direction; for a rotation angle of 0 degree and an L0 state, a direction in which liquid crystal molecules in the liquid crystal layer in contact with the second alignment layer are twisted with respect to liquid crystal molecules in the liquid crystal layer in contact with the first alignment layer is a liquid crystal twist direction; the alignment rotation direction is opposite to the liquid crystal twist direction.

In some implementations, the rotation angle is a sum of a theoretical compensation angle and a correction angle, for a rotation angle of 0 degree and an L0 state, an angle at which liquid crystal molecules in the liquid crystal layer in contact with the second alignment layer are twisted with respect to liquid crystal molecules in the liquid crystal layer in contact with the first alignment layer is a liquid crystal twist angle, and the theoretical compensation angle is equal to the liquid crystal twist angle.

In some implementations, a value of the correction angle is in a range of 0° to 0.3°.

In some implementations, the value of the correction angle is 0.16°.

In some implementations, the display panel is an advanced super dimension switch liquid crystal display panel.

As a second aspect of embodiments of the present disclosure, an embodiment of the present disclosure provides a display device comprising the display panel according to according to any one of the foregoing embodiments.

The above summary is only for illustrative purposes and is not intended to be limiting in any way. In addition to the exemplary aspects, embodiments and features described above, by referring to the accompanying drawings and the following detailed description, further aspects, embodiments and features of the present disclosure will be easy to appreciate.

### BRIEF DESCRIPTION OF THE DRAWINGS

In the drawings, unless otherwise specified, the same reference numerals denote the same or similar portions or elements throughout the multiple drawings. The drawings are not necessarily drawn to scale. It should be understood that these drawings only depict some embodiments according to the present disclosure, and should not be regarded as limiting the scope of the present disclosure.

FIG. 1 is a schematic view illustrating the working principle of an ADS mode liquid crystal display panel;

FIG. 2a is a schematic view of an ADS mode liquid crystal display panel;

FIG. 2b is a schematic view of a VA mode liquid crystal display panel;

FIG. 3 is a cross sectional view of a display panel according to an embodiment of the present disclosure;

FIG. 4 is a plan view of the display panel according to the embodiment of the present disclosure;

FIG. 5 is a plan view of a display panel in the related art;

FIG. 6 is a schematic view of performing a rubbing process on a second alignment layer;

FIG. 7a is a schematic view illustrating the relationship between the contrast ratio and the liquid crystal twist angle of an ADS mode liquid crystal display panel in the related art;

FIG. 7b is a schematic view illustrating the relationship between the contrast ratio and the liquid crystal twist angle of another ADS mode liquid crystal display panel in the related art;

FIG. 7c is a schematic view illustrating the relationship between the contrast ratio and the liquid crystal twist angle of yet another ADS mode liquid crystal display panel in the related art; and

FIG. 8 is a diagram of the relationship between the contrast ratio enhancement rate, the theoretical compensation angle and the rotation angle corresponding to Table 1.

### DETAILED DESCRIPTION

Only some exemplary embodiments are briefly described below. As those skilled in the art can realize, the described embodiments may be modified in various different ways without departing from the spirit or scope of the present disclosure. Therefore, the drawings and description are regarded to be illustrative essentially but not restrictive.

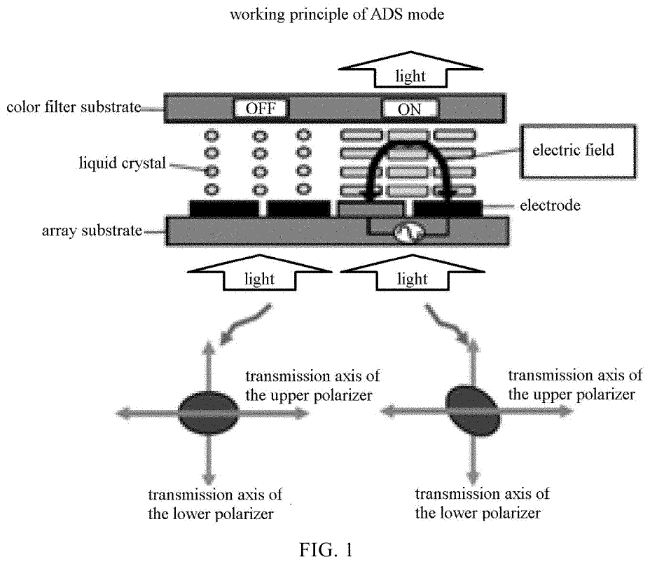

FIG. 1 is a schematic view illustrating the working principle of an ADS mode liquid crystal display panel. As shown in FIG. 1, the ADS mode liquid crystal display panel comprises an array substrate (TFT Glass) and a color filter substrate (CF Glass) arranged opposite to each other. A first alignment layer (not shown) may be disposed on a side of the array substrate facing the color filter substrate, and a second alignment layer (not shown) may be disposed on a side of the color filter substrate facing the array substrate. A liquid crystal layer is located between the array substrate and the color filter substrate. The array substrate includes a pixel electrode and a common electrode. The pixel electrode and the common electrode generate an electric field. In an L0 state (dark state) (indicated by OFF in FIG. 1), the liquid crystal does not deflect and no light passes through. In a non-L0 state (indicated by ON in FIG. 1), the liquid crystal deflects and light passes through the display panel.

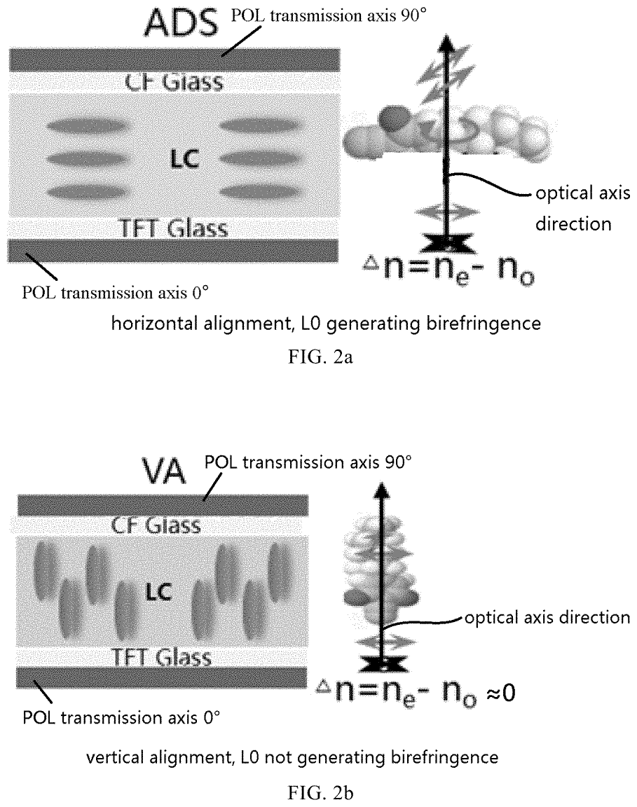

FIG. 2a is a schematic view of an ADS mode liquid crystal display panel. FIG. 2b is a schematic view of a VA mode liquid crystal display panel. The contrast ratio (CR) of the display panel is a ratio of the brightness of the display panel at a gray scale of 255 to the brightness at a gray scale of 0, that is, CR=L255 brightness/L0 brightness. Therefore, the L0 brightness (i.e., the lowest brightness) directly affects the CR value.

As shown in FIG. 2a, for a large-sized ADS TV liquid crystal display panel, the liquid crystals are arranged horizontally (that is, the long axis of the liquid crystal is parallel to the display panel). In the L0 state, birefringence occurs, which results in a high L0 brightness and a low contrast ratio (approximately 1500) of the display panel.

As shown in FIG. 2b, in a vertical alignment (VA) mode liquid crystal display panel, the liquid crystals are arranged vertically (that is, the long axis of the liquid crystal is perpendicular to the display panel). Birefringence will not occur in the L0 state, so that the L0 brightness is low, and the contrast ratio of the display panel is large (approximately 4500). In order to narrow the gap with the VA mode liquid crystal display panel and improve product competitiveness, it is necessary to enhance the contrast ratio of the ADS mode liquid crystal display panel.

There are many factors affecting the L0 brightness of the display panel, such as materials, designs, etc., and the product specifications need to be comprehensively considered for product development. In the case that designs and materials are basically unchanged, improving the process for the product is crucial to the enhancement of the contrast ratio.

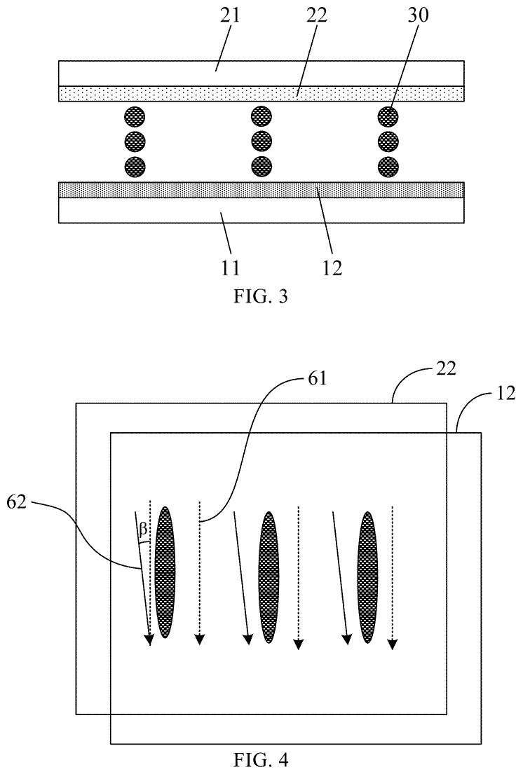

FIG. 3 is a cross sectional view of a display panel according to an embodiment of the present disclosure. FIG. 4 is a plan view of a display panel according to the embodiment of the present disclosure. In both FIGS. 3 and 4, the display panel is in the L0 state. As shown in FIGS. 3 and 4, the display panel may comprise a first substrate 11, a second substrate 21 and a liquid crystal layer 30. The first substrate 11 and the second substrate 21 are arranged opposite to each other, and the liquid crystal layer 30 is between the first substrate 11 and the second substrate 21. The display panel may further comprise a first alignment layer 12 and a second alignment layer 22. The first alignment layer 12 is located on a side of the first substrate 11 facing the second substrate 21, and the second alignment layer 22 is located on a side of the second substrate 21 facing the first substrate 11. As shown in FIG. 4, the alignment direction of the second alignment layer 22 is a second alignment direction 62, and the alignment direction of the first alignment layer 12 is a first alignment direction 61. A rotation angle β of the second alignment direction 62 with respect to the first alignment direction 61 is greater than 0° so as to reduce a liquid crystal twist angle (TA) of the liquid crystal molecules in the liquid crystal layer in contact with the second alignment layer 22 with respect to the liquid crystal molecules in the liquid crystal layer in contact with the first alignment layer 12.

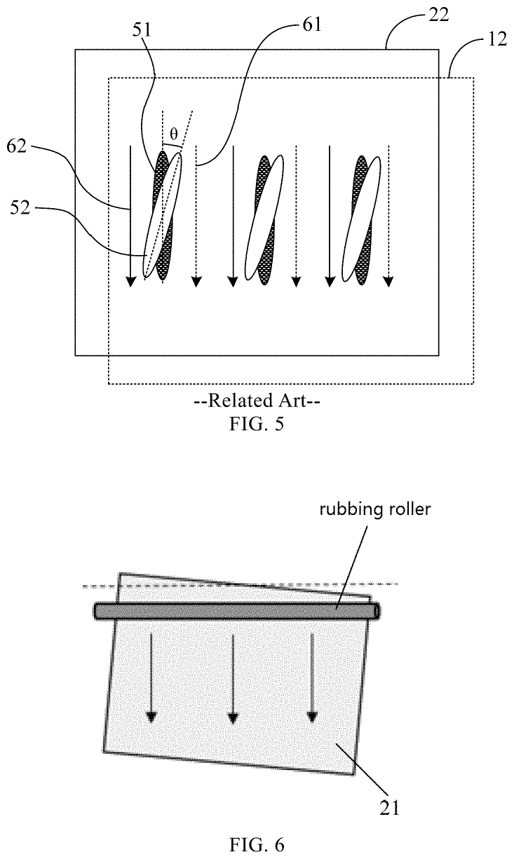

FIG. 5 is a plan view of a display panel in the related art. In FIG. 5, a first substrate 11 and a second substrate 21 are arranged opposed to each other, a first alignment layer 12 is disposed on a side of the first substrate 11 facing the second substrate 21, and a second alignment layer 22 is disposed on a side of the second substrate 21 facing the first substrate 11. A second alignment direction 62 on the second alignment layer 22 is consistent with a first alignment direction 61 on the first alignment layer. As shown in FIG. 5, liquid crystals are disposed between the first substrate 11 and the second substrate 21, and the liquid crystals are arranged horizontally. For the ADS mode, theoretically, in the L0 state (i.e. dark state), the liquid crystals in FIG. 5 will not be twisted, that is, the liquid crystal twist angle of the liquid crystal molecules close to the second substrate 21 (i.e., the liquid crystal molecules in contact with the second alignment layer 22) with respect to the liquid crystal molecules close to the first substrate 11 (i.e., the liquid crystal molecules in contact with the first alignment layer 12) is zero. However, in practice, due to the influence of the material properties of the alignment film, etc., in the L0 state, the above-mentioned liquid crystal twist angle is not equal to zero. As shown in FIG. 5, the liquid crystal twist angle TA (also referred to as a theoretical compensation angle θ) of liquid crystal molecules 52 close to the second substrate 21 with respect to liquid crystal molecules 51 close to the first substrate 11 is greater than 0, which results in light leakage of the display panel in the L0 state, such that the display panel has a low contrast ratio.

Therefore, in the context of the present disclosure, the “liquid crystal twist direction” and “liquid crystal twist angle” refer to a twist direction and a twist angle related to the properties of liquid crystal molecules exhibited by the liquid crystal molecules in the technical solution shown in FIG. 5 (that is, in the technical solution with the rotation angle of 0 degree and the L0 state). The inventors have noticed that various liquid crystal molecules almost all exhibit a “liquid crystal twist direction” and a “liquid crystal twist angle” in the technical solution shown in FIG. 5. Therefore, the examples of the present disclosure are intended to provide improvements for the “liquid crystal twist direction” and “liquid crystal twist angle” generated by the rotation angle of 0 degree and the L0 state.

In the display panel according to an embodiment of the present disclosure, the rotation angle β of the second alignment direction 62 with respect to the first alignment direction 61 is greater than 0°, that is, the second alignment direction 62 is not parallel to the first alignment direction 61. Therefore, in the L0 state, the second alignment direction 62 can adjust the liquid crystal twist angle (i.e., reducing the twist angle of the liquid crystal molecules close to the second alignment layer 22 with respect to the liquid crystal molecules close to the first alignment layer 12). As a result, light leakage of the display panel in the L0 state is reduced, the brightness of the display panel in the L0 state is decreased, and the contrast ratio of the display panel is enhanced.

In an embodiment, as shown in FIGS. 3 and 4, in the L0 state of the display panel, the long axis direction of liquid crystals is parallel to the surface of the first substrate 11 or the second substrate 21. In other words, the liquid crystal molecules are arranged horizontally. For the display panel of this structure, the display panel may be an ADS TV product. According to the embodiment of the present disclosure, it is possible to reduce light leakage of the display panel in the L0 state, decrease the brightness of the display panel in the L0 state can be decreased, and improve the contrast ratio of the display panel.

In an embodiment, as shown in FIG. 4, the direction in which the alignment direction 62 (second alignment direction) of the second alignment layer 22 is rotated with respect to the alignment direction 61 (first alignment direction) of the first alignment layer 12 is called an alignment rotation direction. As shown in FIG. 5, in the case where the alignment direction 62 of the second alignment layer is parallel to the alignment direction 61 of the first alignment layer, and the display panel is in the L0 state, the direction in which the liquid crystals close to the second alignment layer 22 are twisted with respect to the liquid crystals close to the first alignment layer 12 is called a liquid crystal twist direction. In order to reduce the liquid crystal twist angle of the liquid crystal molecules close to the second alignment layer 22 with respect to the liquid crystal molecules close to the first alignment layer 12, the alignment rotation direction is opposite to the liquid crystal twist direction. For example, in FIG. 5, in the L0 state, the twist direction of the liquid crystals close to the second substrate 21 is clockwise with respect to the liquid crystals close to the first substrate 11, thus the alignment rotation direction of the alignment direction of the second alignment layer with respect to the alignment direction of the first alignment layer in FIG. 4 is counterclockwise. As a result, the liquid crystal twist angle of the liquid crystal molecules close to the second substrate 21 with respect to the liquid crystal molecules close to the first substrate 11 in FIG. 5 can be reduced, which effectively decreases the brightness of the display panel in the L0 state, and improves the contrast ratio of the display panel.

FIG. 6 is a schematic view of performing a rubbing process on the second alignment layer. When the second alignment layer is being rubbed, the second substrate may be rotated by an angle of β in a direction opposite to the rotation angle β, and rubbing alignment is then performed on the second alignment layer. For example, in FIG. 4, the direction of the rotation angle β is counterclockwise. Thus, when rubbing alignment is performed on the second alignment layer, the second substrate 21 is rotated clockwise by an angle of β with respect to the horizontal direction (indicated by the dashed line in FIG. 6), and rubbing alignment is performed on the second alignment layer using a rubbing roller.

In an embodiment, one of the first substrate 11 and the second substrate 21 may be an array substrate, and the other may be a color filter substrate. The material of the first alignment layer and the second alignment layer may include polyimide (PI).

As shown in FIG. 4, in an embodiment, the rotation angle β of the alignment direction 62 (second alignment direction) of the second alignment layer 22 with respect to the alignment direction 61 (first alignment direction) of the first alignment layer is a sum of a theoretical compensation angle θ and a correction angle λ. The expression of the rotation angle β can be: β=−(θ+λ), where β is the rotation angle of the alignment direction of the second alignment layer with respect to the alignment direction of the first alignment layer, θ is the theoretical compensation angle, and λ is the correction angle.

In the expression of the rotation angle β, “−” indicates that the direction of β is opposite to the direction of θ, that is, the alignment rotation direction (the direction in which the alignment direction of the second alignment layer 22 is rotated with respect to the alignment direction of the first alignment layer 12) is opposite to the liquid crystal twist direction (the direction in which the liquid crystal molecules close to the second alignment layer 22 are twisted with respect to the liquid crystal molecules close to the first alignment layer 12).

Exemplarily, in the case that the alignment direction 62 of the second alignment layer 22 is parallel to the alignment direction 61 of the first alignment layer 12, in the L0 state (dark state) of the display panel, the angle at which the liquid crystal molecules close to the second alignment layer 22 (i.e., liquid crystal molecules in contact with the second alignment layer 22) are twisted with respect to the liquid crystal molecules close to the first alignment layer 12 (i.e., liquid crystal molecules in contact with the first alignment layer 12) is a liquid crystal twist angle. In this case, the theoretical compensation angle is equal to the liquid crystal twist angle.

It can be understood that, in practical production, a product sample may be first fabricated, the alignment direction of the second alignment layer is set to be parallel to the alignment direction of the first alignment layer, and the liquid crystal twist angle is obtained by testing in the L0 state of the display panel. The theoretical compensation angle is obtained based on the liquid crystal twist angle, and the specific value and direction of the rotation angle β are further calculated. In subsequent production, the alignment direction of the second alignment layer is set according to the specific value and direction of the rotation angle β.

In an embodiment, the correction angle λ is in the range of 0° to 0.3°. The value of the correction angle λ may be any value greater than 0° and less than 0.3°. Optionally, the value of the correction angle λ is 0.16°.

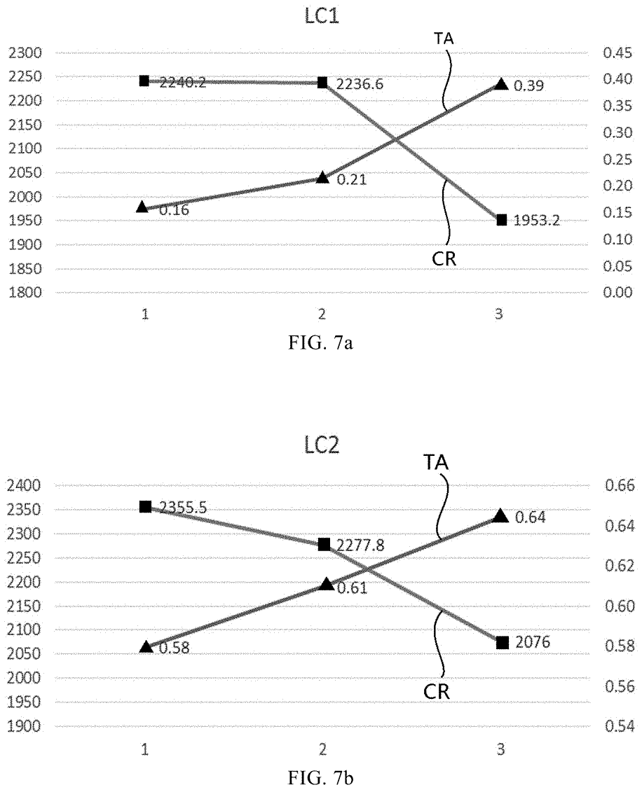

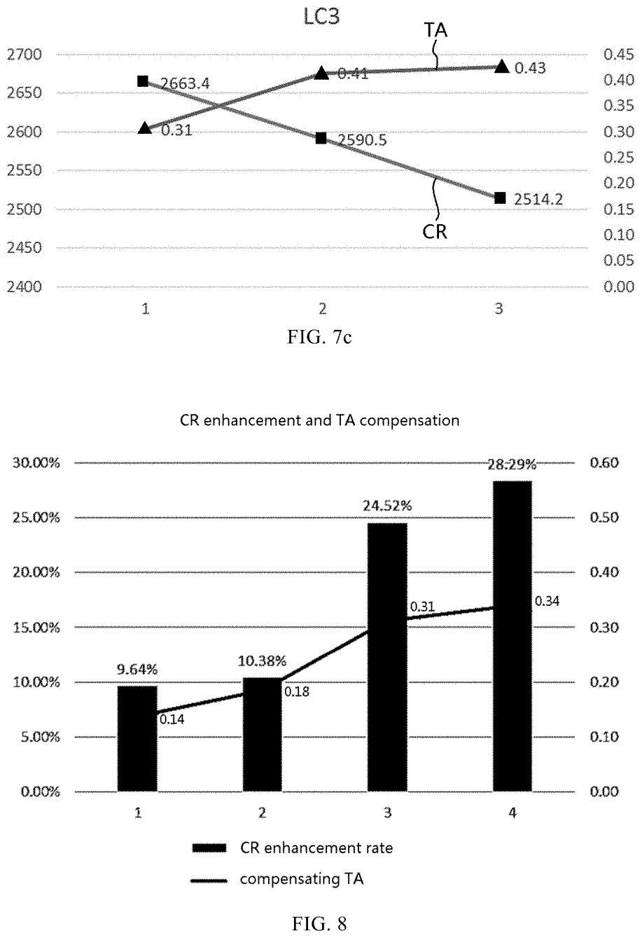

FIG. 7a is a schematic view illustrating the relationship between the contrast ratio and the liquid crystal twist angle of an ADS mode liquid crystal display panel in the related art. FIG. 7b is a schematic view illustrating the relationship between the contrast ratio and the liquid crystal twist angle of another ADS mode liquid crystal display panel in the related art. FIG. 7c is a schematic view illustrating the relationship between the contrast ratio and the liquid crystal twist angle of another ADS mode liquid crystal display panel in the related art. The square and triangle corresponding to the same abscissa (1, 2 or 3) represent the contrast ratio and the liquid crystal twist angle of the same example, respectively. Therefore, by fitting, the curve of the contrast ratio is shown as CR, and the curve of the liquid crystal twist angle is shown as TA. It can be seen from FIGS. 7a, 7b and 7c that as the liquid crystal twist angle TA increases, the contrast ratio CR of the display panel decreases.

Table 1 is a table of the relations between the contrast ratio enhancement rate of the display panel, the theoretical compensation angle and the rotation angle. FIG. 8 is a diagram of the relations between the contrast ratio enhancement rate, the theoretical compensation angle θ, and the rotation angle corresponding to Table 1. In the case of obtaining the theoretical compensation angle, the rotation angle is calculated by using the technical solution of the embodiment of the present disclosure, so that the contrast ratio of the display panel is enhanced.

TABLE 1
a table of the relations between the contrast ratio
enhancement rate of the display panel, the theoretical
compensation angle and the rotation angle

| Contrast ratio | Theoretical compensation | Rotation |
|---|---|---|
| enhancement rate | angle θ (°) | angle β (°) |
| 9.64% | 0.14 | 0.3 |
| 10.38% | 0.18 | 0.35 |
| 24.52% | 0.31 | 0.45 |
| 28.29% | 0.34 | 0.5 |

Based on the inventive concept of the foregoing embodiments, an embodiment of the present disclosure further provides a display device comprising the display panel according to the foregoing embodiments. The display device may be any product or component with a display function, such as a mobile phone, a tablet computer, a television, a monitor, a notebook computer, a digital photo frame, a navigator, and so on.

According to the technical solutions of embodiments of the present disclosure, the rotation angle β of the second alignment direction with respect to the first alignment direction is greater than 0°, that is, the second alignment direction 62 is not parallel to the first alignment direction 61. Therefore, in the L0 state, the second alignment direction 62 can adjust the liquid crystal twist angle (i.e., reducing the twist angle of the liquid crystal molecules close to the second alignment layer with respect to the liquid crystal molecules close to the first alignment layer). As a result, light leakage of the display panel in the L0 state is reduced, the brightness of the display panel in the L0 state is decreased, and the contrast ratio of the display panel is enhanced.

In the description of this specification, it should be understood that the orientations or positional relations indicated by the terms such as “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, and the like are based on the orientations or positional relations shown in the drawings, which are only for the convenience of describing the present disclosure and simplifying the description, and do not indicate or imply an indicated device or element must have a specific orientation, or be constructed and operated in a specific orientation, and therefore cannot be construed as a limitation to the present disclosure.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly include one or more of these features. In the description of the present disclosure, “plurality” means two or more, unless specifically defined otherwise.

In the present disclosure, unless expressly specified and defined otherwise, the terms such as “installation”, “connected”, “connection”, “fixation”, etc. should be understood broadly, for example, they can be fixed connection, detachable connection or integral connection; they can be mechanical connection, electrical connection or communication; they can be direct connection or indirect connection via an intermediate medium, or communication between two elements or interaction between two elements. Those ordinarily skilled in the art may understand the specific meanings of the above terms in the present disclosure based on specific situations.

In the present disclosure, unless expressly specified and defined otherwise, the first feature being “on” or “under” the second feature may include the first feature being in direct contact with the second feature, and may also include the first feature and the second feature being not in direct contact but in contact with each other via another feature therebetween. Moreover, the first feature being “on”, “above” and “over” includes the first feature being directly above and diagonally above the second feature, or it simply means that the level height of the first feature is larger than that of the second feature. The first feature being “under”, “below” and “beneath” the second feature includes the first feature being directly below and diagonally below the second feature, or it simply means that the level height of the first feature is smaller than that of the second feature.

The above disclosure provides many different embodiments or examples for implementing different structures of the present disclosure. In order to simplify the present disclosure, components and settings of specific examples are described above. Of course, they are only examples, and are not intended to limit the present disclosure. In addition, the present disclosure may repeat reference numerals and/or reference letters in different examples, and this repetition is for the purpose of simplification and clarity and does not itself indicate the relationships between the various embodiments and/or settings discussed.

What have been described are only specific embodiments of the present disclosure, but the protection scope of the present disclosure is not so limited. Any variations or substitutions that can be easily conceived by a skilled person familiar with this technical field shall be encompassed within the protection scope of the present disclosure. Thus, the protection scope of the present disclosure shall be based on that of the claims.

What is claimed is:

1. A display panel, comprising:
a first substrate;
a second substrate arranged opposite to the first substrate;
a liquid crystal layer between the first substrate and the second substrate;
a first alignment layer on a side of the first substrate facing the second substrate; and
a second alignment layer on a side of the second substrate facing the first substrate;
wherein a rotation angle of an alignment direction of the second alignment layer with respect to an alignment direction of the first alignment layer is greater than 0 degree.

2. The display panel according to claim 1, wherein a long axis direction of liquid crystal molecules in the liquid crystal layer is parallel to at least one of a surface of the first substrate and a surface of the second substrate.

3. The display panel according to claim 1, wherein a direction in which the alignment direction of the second alignment layer is rotated with respect to the alignment direction of the first alignment layer is an alignment rotation direction;
for a rotation angle of 0 degree and an L0 state, a direction in which liquid crystal molecules in the liquid crystal layer in contact with the second alignment layer are twisted with respect to liquid crystal molecules in the liquid crystal layer in contact with the first alignment layer is a liquid crystal twist direction;
the alignment rotation direction is opposite to the liquid crystal twist direction.

4. The display panel according to claim 1, wherein the rotation angle is a sum of a theoretical compensation angle and a correction angle,
for a rotation angle of 0 degree and an L0 state, an angle at which liquid crystal molecules in the liquid crystal layer in contact with the second alignment layer are twisted with respect to liquid crystal molecules in the liquid crystal layer in contact with the first alignment layer is a liquid crystal twist angle, and the theoretical compensation angle is equal to the liquid crystal twist angle.

5. The display panel according to claim 4, wherein a value of the correction angle is in a range of 0° to 0.3°.

6. The display panel according to claim 5, wherein the value of the correction angle is 0.16°.

7. The display panel according to claim 1, wherein the display panel is an advanced super dimension switch liquid crystal display panel.

8. A display device comprising the display panel according to claim 1.

9. The display device according to claim 8, wherein a long axis direction of liquid crystal molecules in the liquid crystal layer is parallel to at least one of a surface of the first substrate and a surface of the second substrate.

10. The display device according to claim 8, wherein a direction in which the alignment direction of the second alignment layer is rotated with respect to the alignment direction of the first alignment layer is an alignment rotation direction;
for a rotation angle of 0 degree and an L0 state, a direction in which liquid crystal molecules in the liquid crystal layer in contact with the second alignment layer are twisted with respect to liquid crystal molecules in the liquid crystal layer in contact with the first alignment layer is a liquid crystal twist direction;
the alignment rotation direction is opposite to the liquid crystal twist direction.

11. The display device according to claim 8, wherein the rotation angle is a sum of a theoretical compensation angle and a correction angle,
for a rotation angle of 0 degree and an L0 state, an angle at which liquid crystal molecules in the liquid crystal layer in contact with the second alignment layer are twisted with respect to liquid crystal molecules in the liquid crystal layer in contact with the first alignment layer is a liquid crystal twist angle, and the theoretical compensation angle is equal to the liquid crystal twist angle.

12. The display device according to claim 11, wherein a value of the correction angle is in a range of 0° to 0.3°.

13. The display device according to claim 12, wherein the value of the correction angle is 0.16°.

14. The display device according to claim 8, wherein the display panel is an advanced super dimension switch liquid crystal display panel.
